(19) United States
(12) Patent Application Publication
(10) Pub. No.: US 2008/0284583 A1
(43) Pub. Date: Nov. 20, 2008

(54) Electronic Compass

(76) Inventor: Yung-Fa Lin, Banqiao City (TW)

Correspondence Address: RABIN & BERDO, P.C., Suite 500, 1101 14 Street, N.W., Washington, DC, 20005, US

(21) Appl. No.: 11/749,815

(22) Filed: May 17, 2007

(51) Int. Cl. G08B 25/00

(52) U.S. Cl. 340/525

(57) ABSTRACT

An electronic compass, which uses an induction coil unit and action force generated from the earth's magnetic field to detect directions, is able to show data on a display panel. Since data on the display panel is reflected on the inclined plane ahead of the present invention, a driver driving on the road is able to look steadily at data reflected from this invention, so as to efficaciously reduce probability of traffic accidents due to observing data by lowering one's head. The induction coil unit described is easily understood compared with known techniques, thus the production cost is relatively low and this inexpensive invention can be popularly accepted on the market.

### BACKGROUND OF THE INVENTION

1. Field of the Invention

The present invention is related to an electronic compass for direction detection, and more particularly, an electronic compass with a low manufacture cost and a function for displaying inverted images of directional data.

2. Description of the Prior Art

With reference to FIG. 1, which shows the elevational view according to the known electronic compass, comprising a housing 101, a display panel 102, and several control buttons 103, wherein the display panel 102 and the control button 103 are configured on the surface of the housing 101. Functions of the electronic compass 10 are control and adjustment in navigation, temperature detection, and time display by the control button 103, and these measured data regarding direction, temperature around environment, and time are shown on the display panel 102. The electronic compass 10, which is installed within the general motor vehicle, uses an induction coil of the electronic compass 10 to detect directions of a motor vehicle, and delivers signals calculated by the micro control unit of the electronic compass 10 to the display panel 102. Furthermore, as to consideration of convenience, functions of indicating both real time and temperature difference existing in the environment are designed into the known electronic compass 10. However, the fact that the electronic compass 10 is installed on a vertical plane within a motor vehicle leads to shifting of a driver's line of vision to the display panel 102 while the driver is simultaneously driving a car on a road, and thereby raises the possibility of a traffic accident. Additionally, the high production cost of the known electronic compass 10 is derived from adoption of an accurate structure constructing the induction coil for measurement is not suitable to the general public, and the control button 103 with a complex operation mode further complicates its circuits. Thus, the known electronic compass 10 is usually produced for application of advanced navigation.

### SUMMARY OF THE INVENTION

On account of the above request, the inventor was devoted to designing a brand-new electronic compass according to experience accumulated after many years of study. The feature of the present invention is aimed at providing a low-cost and easy-to-use electronic compass that effectively helps improve safety in driving.

In order to achieve the above objectives, the present invention comprises a base, a circuit module, a housing, a display panel, and a rebound lid, wherein a battery socket as well as a battery cover are configured on the bottom of the base, and a circuit module is configured on the top of the base, and then the base is coupled with the housing. A display panel is configured on the surface of the housing and a coupling mechanism is formed at one side of the housing, wherein the coupling mechanism of the housing, by a pivot, is combined with a spring and a coupling mechanism of the rebound lid to construct a unity. Wherein a male fastener is configured on the surface of the above rebound lid, and provides for coupling with a female fastener. A tact switch is implemented next to the female fastener, wherein the rebound lid relies on a spring to bounce and thus forms an adequate angle when a user presses the tact button. At this moment, reflected data of the display panel on the surface of the rebound lid creates a condition that a user is able to look steadily at data on the surface of the rebound lid. Additionally, the present invention contains an induction coil unit for direction detection, which is easily understood when compared with known technology and has simple circuits, thereby reducing the production cost, thus conforming to requests from the general public.

To enable a further understanding of said objectives and the technological contents of the invention herein, the description of the preferred embodiments with drawings is listed as follows.

### BRIEF DESCRIPTION OF THE DRAWINGS

FIG. 1 shows the elevational view according to the known electronic compass.

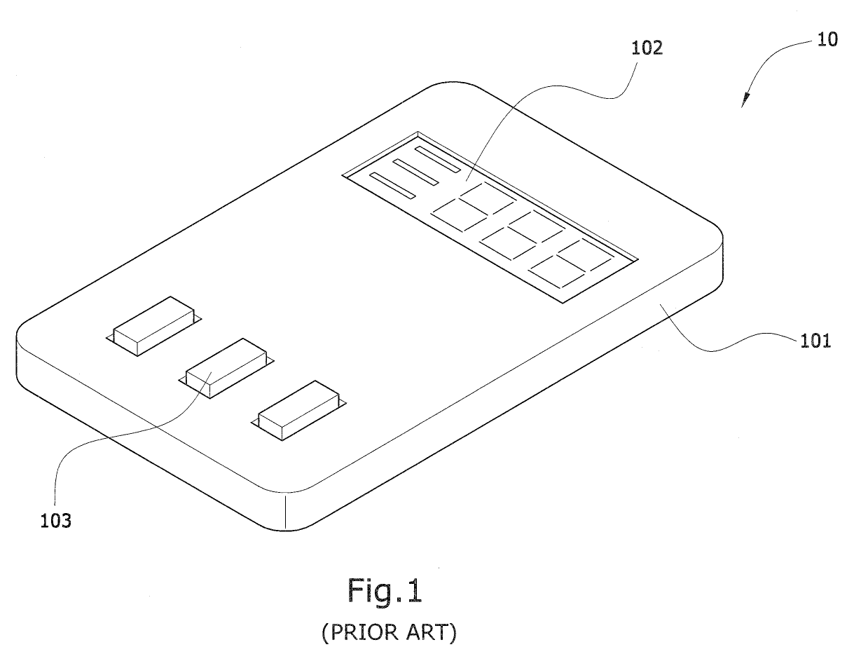

FIG. 2 shows the block diagram of electronic compass according to the present invention.

FIG. 3 shows the exploded elevational view according to the present invention.

FIG. 4 shows the elevational view according to the present invention.

FIG. 5 shows a drawing in usage according to the present invention.

FIG. 6 shows a first drawing in usage according to the present invention.

FIG. 7 shows a second drawing in usage according the present invention.

### DETAILED DESCRIPTION OF THE PREFERRED EMBODIMENTS

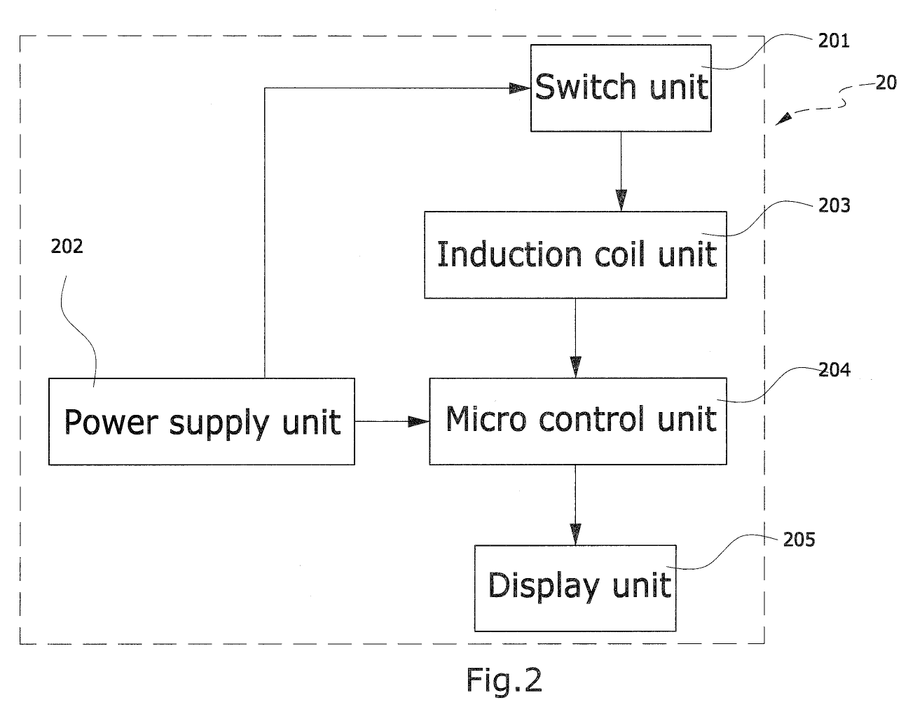

With reference to FIG. 2, which shows a block diagram of the present invention relating to an electronic compass, wherein the electronic compass 20 comprises a switch unit 201, a power supply unit 202, an induction coil unit 203, a micro control unit 204, and a display unit 205. Wherein the switch unit 201, the power supply unit 202, the induction coil unit 203, the micro control unit 204, and the display unit 205 are configured within the electronic compass 20. With the switch unit 201 turned on, the power supply unit 202 is electrified to power on the induction coil unit 203 simultaneously. At this moment, the magnetic force for detection of the earth's natural magnetic field (i.e. polarity of the North Pole or the South Pole) is created through the induction coil unit 203. The detected magnetic field is transferred to a signal, which is forwarded to the micro control unit 204 for data calculation, and this data is shown on the display unit 205. Thereupon, the geographic direction ahead of a motor vehicle can be figured out via operations among these units, and thus an immediate detection and display of the front direction by cooperation of each unit proves that the operational model is of simplification. Meanwhile, the above induction coil unit 203 for navigation is a very common coil on the market, thus the objective of low production cost and popularity can be realized.

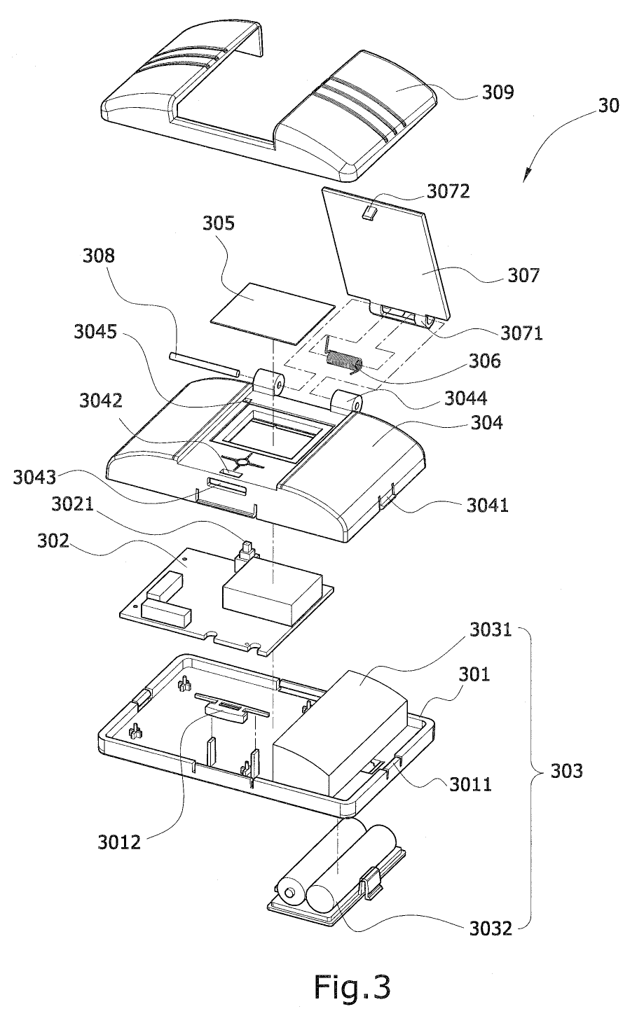

With reference to FIG. 3, which shows the exploded elevational view according to the present invention, wherein the present invention is primarily configured to an electronic compass 30, which comprises a base 301, a circuit module 302, a battery unit 303, a housing 304, a display panel 305, a spring 306, a rebound lid 307, a pivot 308, and an external cover 309, wherein a number of fastening mechanisms 3011 are formed around the periphery of the base 301. A tact switch 3012 is configured on one side of the periphery of the base 301, and the circuit module 302 is defined on one side of the surface of the base 301, on which the starting switch 3021 is configured. The battery unit 303 consists of a battery socket 3031 and a battery cover 3032, wherein both are configured next to the circuit module 302 and on another surface of the base 301. Furthermore, a number of fastening mechanisms 3041 are formed around the periphery of the housing 304, which provides a mutual coupling with the corresponding fastening mechanisms 3011. An opening 3043 is formed on one side of the housing 304 for implementation of the tact switch 3012. The display panel 305 is configured on the surface of the housing 304, whereby the display panel 305 shows data by a general lamp or an LED lighting module. With a female fastener 3042 formed next to the display panel 305, a coupling mechanism 3044 is also formed on a corresponding position, whereby the coupling mechanism 3044, relying on a pivot 308, combines with a spring 306 and a coupling mechanism 3071 of the rebound lid 307 to construct an unity. Adjacent to the coupling mechanism 3044, an opening 3045 is formed to provide an implementation position of the starting switch 3021. A male fastener 3072 is formed on the above-mentioned rebound lid 307, whereby the male fastener 3072 is able to mutually engage with the female fastener 3042 of the housing 304. Moreover, an external cover 309 is configured outside of the surface of the housing 304, and an opening is formed at the center of the external cover 309 for opening/closing actions of the rebound lid 307.

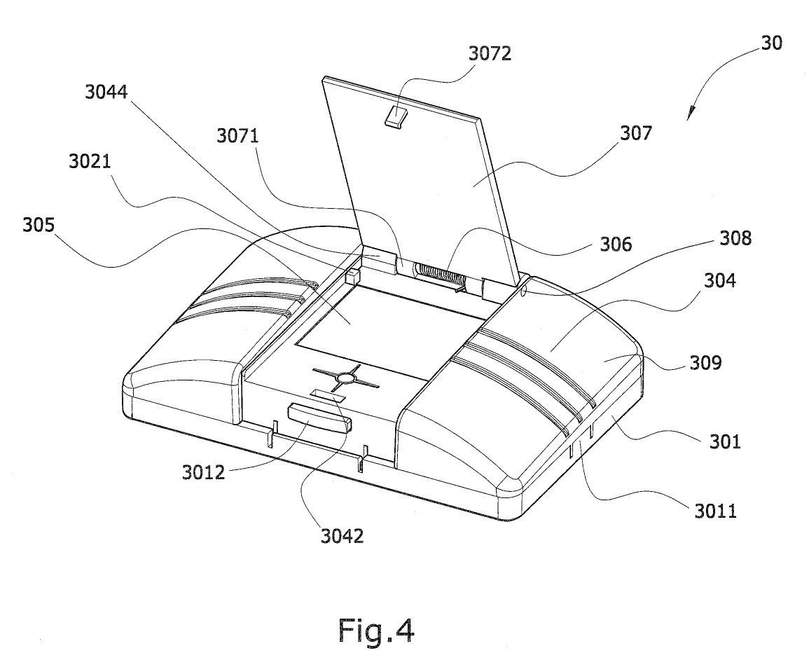

With reference to FIG. 4, which shows an elevational view according to the present invention, wherein the male fastener 3072 of the rebound lid 307 engages with the female fastener 3042 of the housing 304 before usage of the present invention, the electronic compass 30, and maintaining a coupling condition using the tact switch 3012. When the rebound lid 307 is covered on the housing 304, the starting switch 3021 is pressed down and the display panel 305 is powered off, thus the power supply of the electronic compass 30 is not electrified, i.e., the electronic compass 30 is inoperative. Once the tact switch 3012 is pressed, the male fastener 3072 of the rebound lid 307, relying on the bounce of the spring 306, is able to separate from the female fastener 3042 of the housing 304 to rotate to an adequate angle away from the housing 304 by mutual effect among the coupling mechanism 3044, the coupling mechanism 3071, and the pivot 308. At such time, the fact that the rebound lid 307 separates from the starting switch 3021 means the electrified electronic compass 30, whereby the display panel 305 begins to show data relating to geographic directions ahead of a motor vehicle. When terminating operation, the user is able to manually press the rebound lid 307 to contact the surface of the housing 304, whereby the male fastener 3072 engages with the female fastener 3042, and returns back to an inoperative condition.

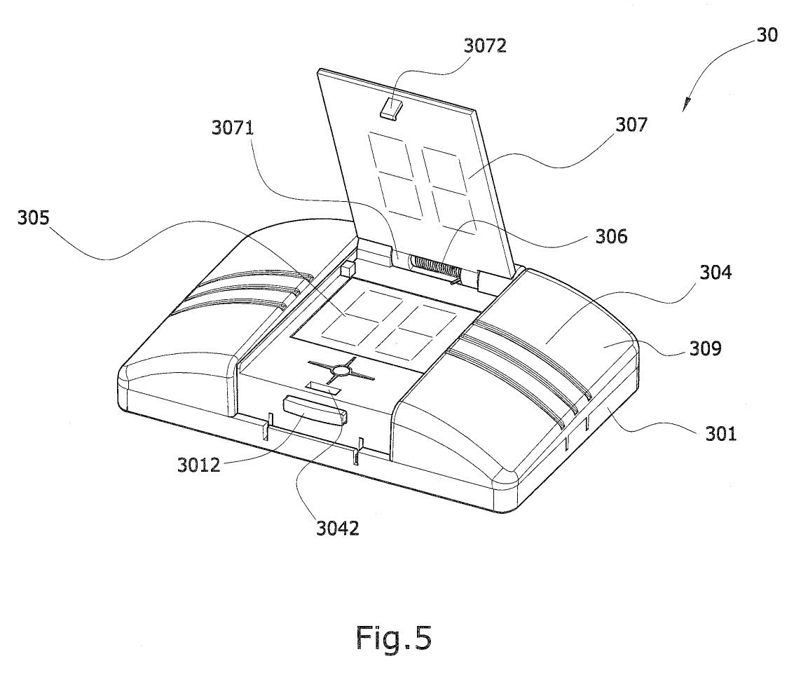

With reference to FIG. 5, which shows a drawing in usage according to the present invention, wherein an adequate angle formed between the rebound lid 307 and the housing 304 is dependent on the bounce of the spring 306 after the tact button 3012 is pressed down. Owing to an electrical link between the switch unit 201 and the starting switch 3021, the starting switch 3021, without restriction of pressure by the rebound lid 307, turns on the switch unit 201, and thereby outputting a signal to enable the power supply unit 202, thus powering on the electronic compass 30. At this moment, the above electrified induction coil unit 203 starts to detect geographic directions ahead of a motor vehicle, and forwards signals detected to the micro control unit 204, which conducts calculation to data according to received signals and forwards data to the display panel 305. Because of an electrical link between the display unit 205 and the display panel 305, the calculated data can be shown on the display panel 305. Further, the data, as a format of light shown on the display panel 305, can be reflected on the surface of the rebound lid 307. Moreover, notwithstanding inverted image that data is shown on the display panel 305, a positive image of data can be displayed on the rebound lid 307 with a reflection of light on the surface of the rebound lid 307. Because the present invention relating to an electronic compass 30 can be installed on a plane surface, for instance, a specific plane observed within the motor vehicle, a driver is able to look steadily at data on the surface of the rebound lid 307, after the rebound lid is bounced, and thus prevents danger derived from observing data by lowering of one's head, as a method to read data for the known electronic compass. Therefore, a driver driving a motor vehicle on a road can efficaciously avoid danger due to distractions.

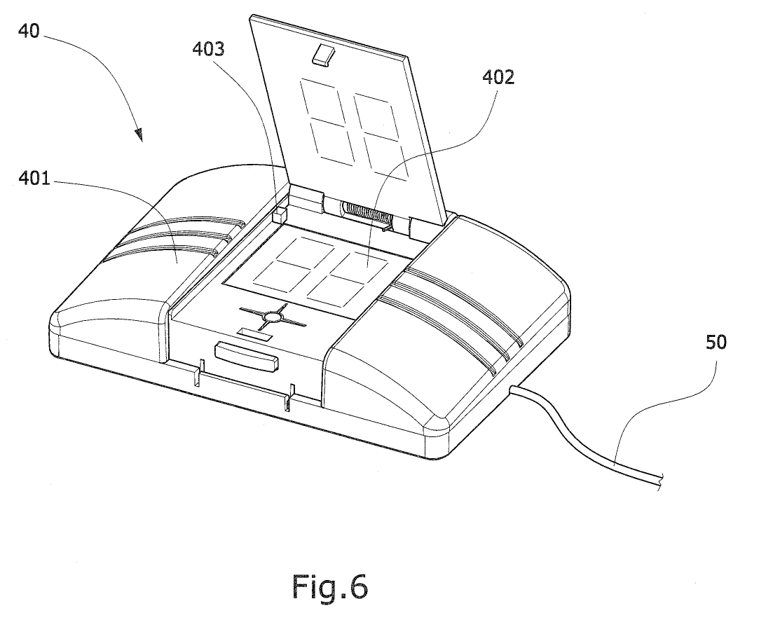

With reference to FIG. 6, which shows a first drawing in usage according to the present invention, wherein the present invention is primarily configured to an electronic compass 40, which comprises a housing 401, a display panel 402, a starting switch 403, and an electrical wire 50. Wherein the display panel 402 is configured on the surface of the housing 401, and the starting switch 403 is next to the display panel 402. The above-mentioned electrical wire 50 is electrically connected to one end of the housing 401, wherein the above switch unit 201, the power supply unit 202, the induction coil unit 203, the micro control unit 204, and the display unit 205 are configured within, and thus are electrically connected to the display panel 402, the starting switch 403, and the electrical wire 50. With the starting switch 403 pressed, the switch unit 201 is induced, thereby turns on the above-mentioned induction coil unit 203. At this moment, the electrical wire 50 which is plugged into an outlet sends electricity to the power supply unit 202, and then the induction coil unit 203 for creation of magnetic field used for detection of the earth's natural magnetic field. The detected magnetic field is transferred into signals, which is forwarded to the above micro control unit 204 for data calculation. Then, the calculated data is sent to the above display panel 402 of the display unit 205.

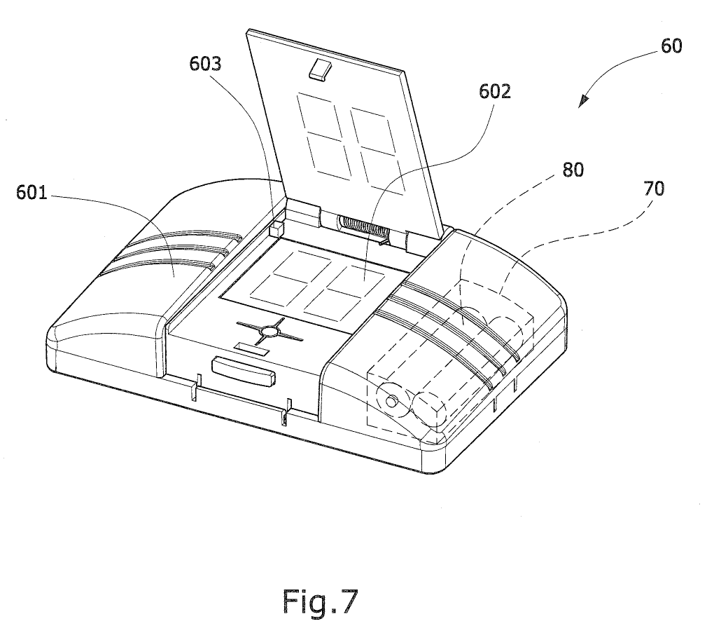

With reference to FIG. 7, which shows a second drawing in usage according the present invention relating to an electronic compass 60, wherein the above power supply unit 202 is electrically connected to a battery unit 70 for implementation of the battery 80, as electric energy of the present invention. The display panel 602 within the above-mentioned display unit 205 contains a LED lighting module, whereby the display panel 602 uses the LED lighting module to reflect data on a plane, which forms an angle of inclination with the housing 601. Data on the display panel 602 is shown as an inverted image, but can display a positive image when inverted image is reflected on the plane. Thus, with this present invention installed within a motor vehicle, the inverted image reflects on the surface of windshield, and whereupon a driver driving on a highway is able to look steadily at data on the windshield, so as to improve driving safety.

As stated above, the embodiment of this present invention achieves the features of an electronic compass with features of providing a low-cost, convenient application, and enhancing driving safety.

In addition, it is to be understood that the embodiments described herein are merely illustrative of the principles of the invention and that a wide variety of modifications thereto may be effected by persons skilled in the art without departing from the spirit and scope of the invention as set forth in the following claims.

In conclusion, this present invention relating to an electronic compass, as a creation, is to extend practicality and progress; the applicant quotes provisions of the Patent Law to apply for a patent.

What is claimed is:

1. An electronic compass, which comprises:
A switch unit, which is configured within the electronic compass, and provides for functions of controlling power-on and power-off for the electronic compass;
A power supply unit, which is electrically connected to the switch unit;
An induction coil unit, which is configured within the electronic compass and is electrically connected to the switch unit and the power supply unit, and receives electrical energy transferred from the power supply unit to create a magnetic field, and finally transforms the magnetic field derived from outside to signals for further delivery;
A micro control unit, which is electrically connected to the induction coil unit, and thereby receives signals transferred from the induction coil unit, thus calculates signals to data for further delivery; and
A display unit, which is electrically connected to the micro control unit, and is able to receive data transferred from the micro control unit.

2. The electronic compass according to claim 1, wherein the electronic compass is electrically connected to an electrical wire.

3. The electronic compass according to claim 1, wherein the battery unit is configured within the electronic compass and provides for several batteries to embed therein.

4. The electronic compass according to claim 1, wherein the display unit contains a LED lighting module.

5. The electronic compass according to claim 1, wherein the housing is configured to the electronic compass for implementation of the switch unit, the power supply unit, the induction coil unit, the micro control unit, and the display unit.

6. An electronic compass, which comprises:
A base, wherein the battery unit is configured on the surface of the base, several fastening mechanisms are formed by the edges and a tact switch is configured on one side of the periphery;
A circuit module, which is configured on another surface of the base, and is electrically connected to a starting switch;
A housing, wherein several fastening mechanisms for mutual coupling with several fastening mechanisms of the base are formed on the edges of the housing, an opening is formed on one side of the periphery for implementation of the tact switch, a display panel is configured on the surface, a female fastener next to the display panel and a coupling mechanism on the opposite side of the female fastener are formed, and another opening next to the coupling mechanism is formed for implementation of the starting switch; and
A rebound lid, wherein a coupling mechanism is formed on one side of the rebound lid, whereby the coupling mechanism, by means of a pivot, combines with a spring and another coupling mechanism of the housing to form a unity; on the other side of the rebound lid, a male fastener is formed for mutual coupling with the female fastener of the housing.
